(19) United States
(12) Patent Application Publication
(10) Pub. No.: US 2004/0078932 A1
(43) Pub. Date: Apr. 29, 2004

(54) Torque regulator device for hinge assembly

(76) Inventor: Ding-Hone Su, Hsi-Chih City (TW)

Correspondence Address: BIRCH STEWART KOLASCH & BIRCH, PO BOX 747, FALLS CHURCH, VA, 22040-0747, US

(21) Appl. No.: 10/281,364

(22) Filed: Oct. 28, 2002

(51) Int. Cl. E05D 11/10

(52) U.S. Cl. 16/321

(57) ABSTRACT

A torque regulator device comprises a hinge assembly and a torque generator structure. The hinge assembly comprises a pivotal axle and two rotating elements oppositely connected to the pivotal axle. The rotating elements are further connected to an external structure. When the rotating elements rotate, the torque generator structure generates and regulates by varying the produced torque in accordance with the rotation angle of the rotating elements of the hinge assembly. The hinge assembly is thereby assisted in supporting the external structure that, when folded or unfolded, causes a torque variation, the torque needed by the hinge assembly is thereby reduced, and the service life of the hinge assembly is increased.

### FIELD OF THE INVENTION

The invention relates to a torque regulator device that is assembled with a hinge assembly to regulate the produced torque, which reduces the torque needed from the hinge assembly and increases the service life of the hinge assembly.

### BACKGROUND OF THE INVENTION

In a current notebook portable computer, the display device and the computer main unit are pivotally connected to each other via a hinge assembly. When the user wishes to use the notebook computer, he/she unfold the display device from the computer main unit to reach an adequate angle of view. When the notebook computer is not used, the display device and the computer main unit are folded on each other.

The above hinge assembly that connects the display device to the computer main unit usually provides a same torque regardless the rotation angle of the display device relative to the computer main unit. This results in the following disadvantages.

(1) The torque needed to support the display screen varies according to its inclination angle. When this inclination angle is close to 0 degrees (display device close to the computer main unit), the greatest torque is needed. When the display device is perpendicular to the computer main unit, the torque needed is the smallest. Since the conventional hinge assembly continuously provides a same torque, this latter therefore has to be at least greater than or equal to the maximal required torque corresponding to an inclination angle of the display device close to 0 degrees. When the user wishes to unfold the notebook computer, the force applied has to be greater than the addition of the torque from the hinge assembly and the torque caused by the weight of the display device. When the user wishes to fold the notebook computer, the applied force has to be greater than the torque from the hinge assembly deducted the torque caused by the weight of the display device. Because the torque caused by the display device varies according to its inclination angle, the force applied by the user is therefore not uniform. This applied force is the greatest when the inclination angle is close to zero while the user wants to unfold or fold the notebook computer. The adjustment of the inclination angle of the display device therefore is not ideal. An ideal hinge assembly should allow the user to exert a similar force to fold and unfold the display device regardless its inclination angle.

(2) When the size and the weight of the display device are greater, the torque required from the hinge assembly has to be correspondingly increased. However, if the torque from the hinge assembly increases, the abrasion effects between the rotating elements and the pivotal axle of the hinge assembly are adversely amplified, which shortens the service life of the hinge assembly.

### SUMMARY OF THE INVENTION

Accordingly, it is a principal object of the invention to provide a torque regulator device that is assembled with the hinge assembly to adequately regulate the torque from the hinge assembly.

It is another object of the invention to provide a torque regulator device that can regulate the needed torque from the hinge assembly in accordance with the torque produced by the weight of the external structure (display device). The torque needed from the hinge assembly is therefore reduced, which increases its service life.

Furthermore, it is another object of the invention to provide a torque regulator device that can increase the needed torque as the torque produced by the weight of the external structure increases. The user can thereby conveniently rotate the external structure with the application of a similar force at any inclination angle.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of a torque regulator device according to an embodiment of the invention;

FIG. 2 is an exploded view of a torque regulator device according to an embodiment of the invention;

FIG. 3A, FIG. 3B, and FIG. 3C are schematic views illustrating the operation of the invention; and

FIG. 4 is a perspective view of a torque regulator device according to another embodiment of the invention.

### DETAILED DESCRIPTION OF THE EMBODIMENTS

Wherever possible in the following description, like reference numerals will refer to like elements and parts unless otherwise illustrated.

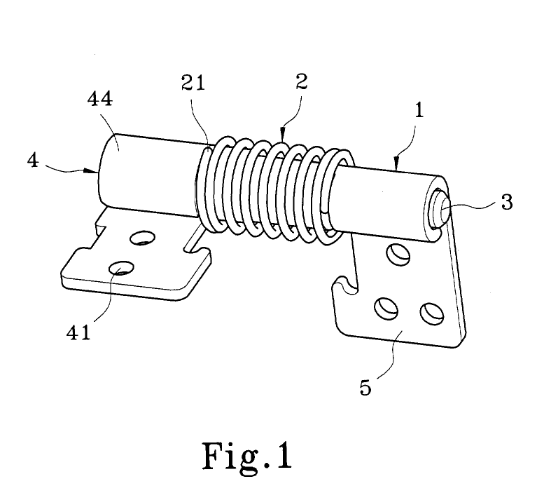

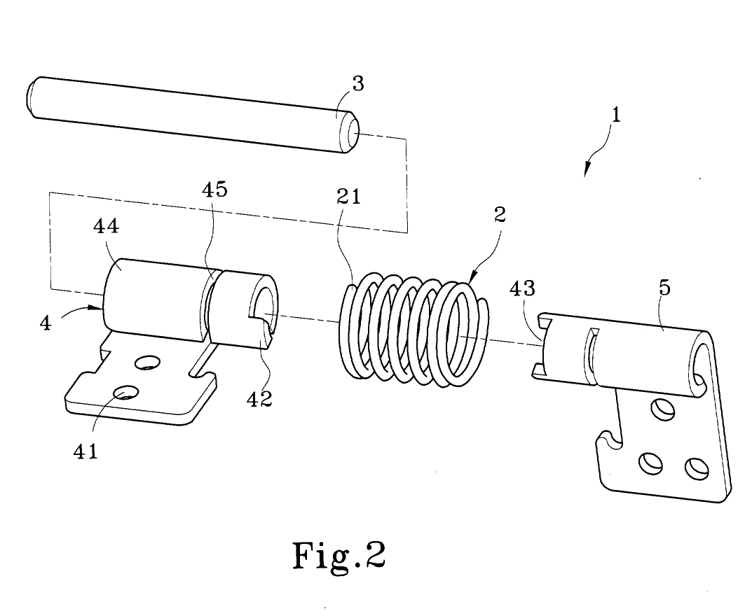

FIG. 1 and FIG. 2 are a perspective view and an exploded view of a torque regulator device for a hinge assembly according to an embodiment of the invention. As illustrated, the torque regulator device of the invention comprises a hinge assembly 1 and a torque generator structure 2. The hinge assembly 1 comprises pivotal axle 3 and two rotating elements 4, 5. The torque generator structure 2 is mounted between the rotating elements 4, 5. The torque generator structure 2 is designed in a manner to provide a torque equal to 0 when the rotating elements 4, 5 are perpendicular to each other. As the rotating elements 4, 5 rotate, the torque generator structure 2 regulates the generated torque according to the rotation angle of the hinge assembly 1. This torque regulation provides an adequate torque to the hinge assembly 1 to support the external structure mounted thereto when this latter is unfolded or folded. As a result, the total amount of torque needed by the hinge assembly is reduced, which lengthens the service life of the hinge assembly.

The rotating elements 4, 5 respectively include fastening holes 41 that are directed to the attachment of an external structure (not shown). The rotating elements 4, 5 respectively include a projection 42 and a corresponding slot 43 for limiting the slide of the projection 42. The rotating elements 4, 5 further respectively include sleeve portions 44 that mount to the pivotal axle 3. A surface of each sleeve portion 44 respectively includes a slot 45 that corresponds to one of two force receiving ends 21 of the torque generator structure 2, via the assembly of which the torque generator structure 2 is connected between the rotating elements 4, 5.

When an external force is applied, the rotating elements 4, 5 synchronously drive the force receiving ends 21 in movement. Depending on the rotation angle of the rotating elements 4, 5, the torque generator structure 2 regulates via accordingly varying the generated torque. The actual torque of the hinge assembly 1 is equal to the difference between the torque from the rotating elements 4, 5 and the torque from the torque generator structure 2. Therefore, different torque values are provided for different rotation angles of the hinge assembly 1, those torque values being relatively smaller compared to the prior art to immobilize the hinge assembly 1. A user therefore applies a smaller torque to operate the hinge assembly 1, which lengthens the service life of the hinge assembly 1.

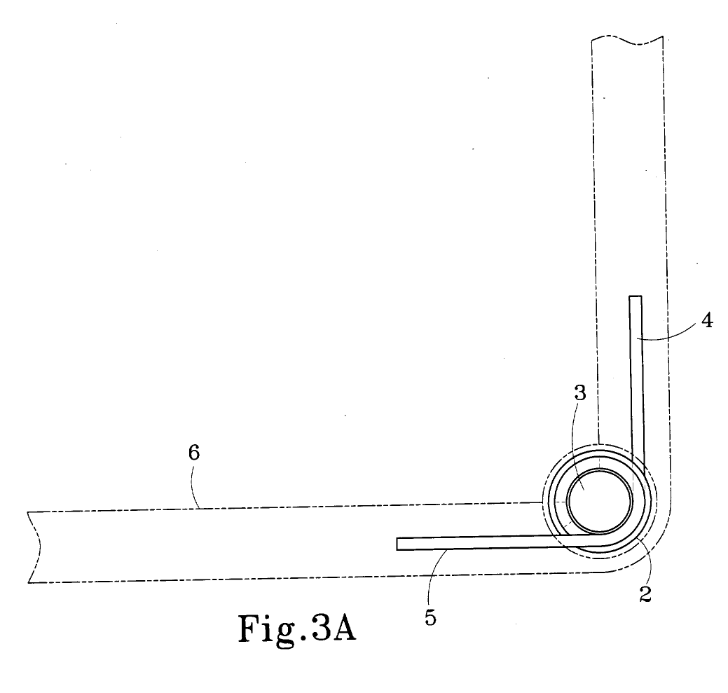

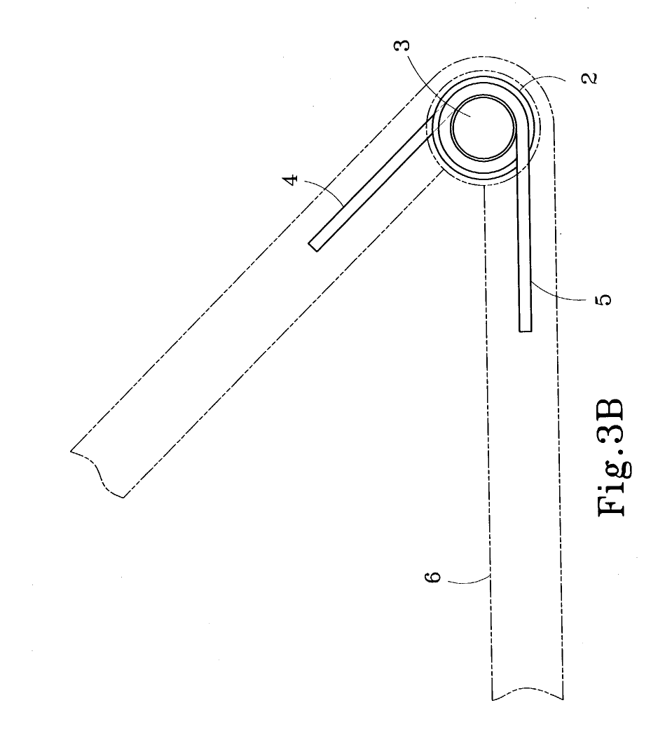

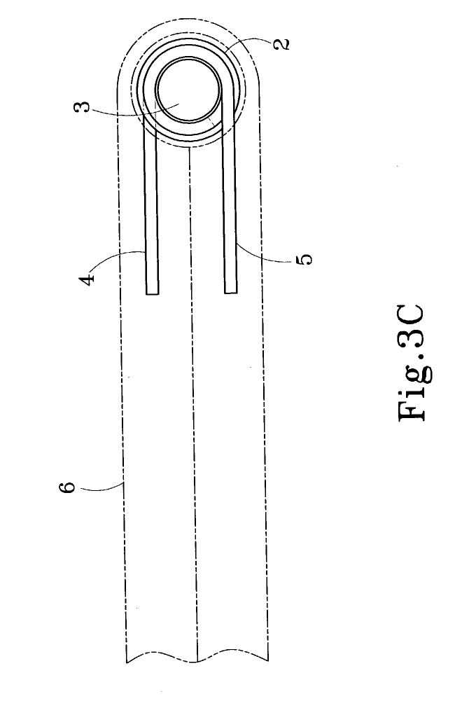

Reference now is made to FIG. 3A, FIG. 3B, and FIG. 3C to describe the operation of the embodiment of the invention. As illustrated, a normal configuration corresponds to a perpendicular positioning (unfold) of the external structure 6, i.e. the rotating elements 4, 5 are perpendicular to each other. In this configuration, the rotating elements 4, 5 and the torque generator structure 2 maintain the same state, the torque generator structure 2 not generating any torque.

When the user exerts an external force to fold the external structure 6, the rotating elements 4, 5 rotate relative to the pivotal axle 3. With the rotation of the rotating elements 4, 5, the slots 45 drive the force receiving ends 21 of the torque generator structure 2, which causes a deformation of the torque generator structure 2 to generate a torque. At this moment, the external force needed to fold the external structure 6 has to be greater than the difference between the actual torque from the hinge assembly 1 and the weight of the external structure 6. The actual torque from the hinge assembly 1 is the addition of frictional forces in the hinge assembly 1 and the torque provided by the deformation of the torque generator structure 2. As the external structure 6 progressively rotates downward, the torque produced by its own weight gradually increases. The deformation of the torque generator structure 2 therefore increases, which produces a greater torque. The actual torque from the hinge assembly 1 therefore correspondingly increases. As a result, the external force is maintained fixed. Once the external structure 6 is completely folded (angle of 0 degree), no torque is needed because the folded external structure 6 is adequately supported. To prevent the torque produced by the torque generator structure 2 from reversely unfolding the external structure 6, the intrinsic torque of the hinge assembly 1 therefore has to be greater than the torque produced by the torque generator structure 2. The external structure 6 can be thereby maintained in a fold configuration.

When the external structure 6 is opened up from a fold configuration, the rotating elements 4, 5 rotate relative to the pivotal axle 3. With the rotation of the rotating elements 4, 5, the slots 45 drive the force receiving ends 21 of the torque generator structure 2, which causes a deformation of the torque generator structure 2 to generate a torque variation. At this moment, the external force needed to open up the external structure 6 has to be greater than the addition of the actual torque from the hinge assembly 1 and the torque produced by the weight of the external structure 6. The actual torque from the hinge assembly 1 is the result of the frictional forces in the hinge assembly 1 deducted the torque provided by the deformation of the torque generator structure 2. As the external structure 6 progressively rotates upward, the torque produced by its own weight gradually decreases. The deformation of the torque generator structure 2 therefore is reduced, which produces a smaller torque. The actual torque from the hinge assembly 1 therefore correspondingly decreases. As a result, the external force is maintained fixed although the rotation angle changes.

Because the torque produced by the torque generator structure 2 partially counteracts against the down-pressing weight of the external structure 6, the torque needed by the hinge assembly 1 is therefore smaller. Abrasion effects are therefore reduced, which increases the service life of the hinge assembly 1.

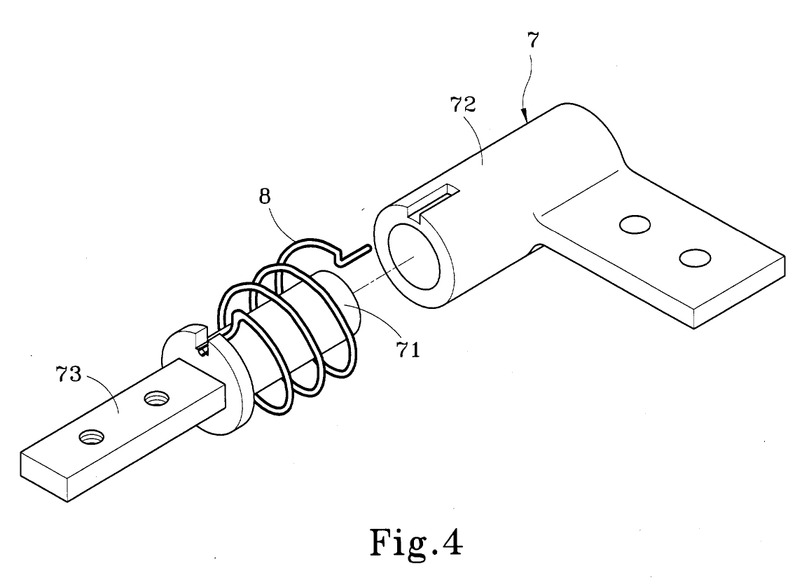

FIG. 4 is a perspective view illustrating another embodiment of the invention. The torque regulator of the invention may be also be implemented for a unidirectional hinge assembly 7. As illustrated, the hinge assembly 7 comprises a pivotal axle 71 and a rotating element 72 pivotally connected to the pivotal axle 71. A torque generator structure 8 is mounted between the rotating element 72 and an attachment element 73. As the hinge assembly rotates, the torque generator structure 8 produces and regulates by varying the produced torque in accordance with the rotation angle of the rotating element 72. At this moment, the actual torque from the hinge assembly 7 is the result of the intrinsic frictional forces in the hinge assembly 7 deducted the torque provided by the deformation of the torque generator structure 8. Therefore, different torque values are provided for different rotation angles of the hinge assembly 7, those torque values being relatively smaller compared to the prior art to immobilize the hinge assembly 7. The service life of the hinge assembly 7 is therefore increased.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A torque regulator device for a hinge assembly, the hinge assembly comprising a pivotal axle and two rotating elements oppositely connected to the pivotal axle, the rotating elements being further connected to an external structure, the torque regulator device comprising:
a sleeve portion, formed on each rotating element and pivotally connected to the pivotal axle, a slot being formed on a surface of the sleeve portion; and
a torque generator structure, mounted between the two rotating elements, two sides of the torque generator structure respectively forming a force receiving end that assembles with the slot of the sleeve portion, thereby when the rotating elements rotate, the torque generator structure generates and regulates by varying the produced torque in accordance with the rotation angle of the rotating elements of the hinge assembly, which assists the hinge assembly in supporting the external structure that when folded or unfolded causes a torque variation, the torque needed by the hinge assembly is thereby reduced, and the service life of the hinge assembly is increased.

2. The torque regulator device of claim 1, wherein the torque generated by the torque generator structure is zero when the two rotating elements are perpendicular to each other.

3. The torque regulator device of claim 1, wherein the torque variation is either unidirectional or bi-directional.

4. The torque regulator device of claim 1, wherein the torque generator structure is a spring.

5. The torque regulator device of claim 1, wherein the torque generator structure is a spring plate.

6. A torque regulator device for a hinge assembly, the hinge assembly comprising a pivotal axle and a rotating element connected to the pivotal axle, the rotating element being further assembled with an attachment element to mount an external structure, the torque regulator device comprising:
a sleeve portion, respectively formed on the rotating element and the attachment element and pivotally connected to the pivotal axle, a slot being formed on a surface of the sleeve portion; and
a torque generator structure, mounted between the rotating element and the pivotal axle, two sides of the torque generator structure respectively forming a force receiving end that assembles with the slot of the sleeve portion, thereby when the rotating element rotates, the torque generator structure generates and regulates by varying the produced torque in accordance with the rotation angle of the rotating element of the hinge assembly, which assists the hinge assembly in supporting the external structure that when folded or unfolded causes a torque variation, the torque needed by the hinge assembly is thereby reduced, and the service life of the hinge assembly is increased.

7. The torque regulator device of claim 6, wherein the torque generated by the torque generator structure is zero when the two rotating element and the attachment element are perpendicular to each other.
